(19) United States
(12) Patent Application Publication
(10) Pub. No.: US 2020/0021547 A1
(43) Pub. Date: Jan. 16, 2020

(54) METHOD OF SETTING A DESIGNEE IN INSTANT MESSAGING

(71) Applicant: Letstalk Technology Limited, Taipei City (TW)

(72) Inventors: Chan-Guan KOH, Taipei City (TW); Chin-Yuan CHEN, Taipei City (TW); Ya-Hsin CHENG, Taipei City (TW)

(21) Appl. No.: 16/197,278

(22) Filed: Nov. 20, 2018

(30) Foreign Application Priority Data
Jul. 12, 2018 (TW) 107124034

(51) Int. Cl. H04L 12/58

(52) U.S. Cl. CPC H04L 51/14; H04L 51/04

(57) ABSTRACT

A method of setting a designee for a user (designator) in instant messaging is proposed. In the instant messaging, the designator operates a designator-side device to select a contact to be a messaging object corresponding to an object-side device, and select another contact to be a messaging designee corresponding to a designee-side device, causing an instant messaging server to activate a deputy mode. In the deputy mode, when the designee-side device is operated to send a message to the object-side device through the instant messaging server, the instant messaging server transmits the message to the object-side device in the name of the designator-side device, and also transmits the message to the designator-side device.

### CROSS-REFERENCE TO RELATED APPLICATION

This application claims priority of Taiwanese Invention Patent Application No. 107124034, filed on Jul. 12, 2018.

### FIELD

The disclosure relates to an instant messaging method, and more particularly to a method of setting a designee for a user in an instant messaging session.

### BACKGROUND

Because of popularity of smartphones, instant messaging software applications, such as WhatsApp, Facebook Messenger, Viber, WeChat, LINE, Instagram, etc., are widely used all over the world, significantly enhancing instantaneity and convenience in transmission of digital messages. However, when one party in an instant messaging session that is held using these applications is unable to reply messages instantly, all that the other party or parties can do is wait, and sometimes things that require immediate attention cannot be dealt with in time.

### SUMMARY

Therefore, an object of the disclosure is to provide a method of setting a designee in instant messaging. The method can alleviate at least one of the drawbacks of the prior art.

According to the disclosure, the method of setting a designee for a user who uses an instant messaging device serving as a designator-side device in an instant messaging session is proposed. The designator-side device corresponds to a contact list which has a plurality of contacts of the user, and is configured to perform instant messaging with multiple instant messaging devices through an instant messaging server. The method includes: by the instant messaging server, receiving, from the designator-side device, designee setting information that indicates a messaging object and a messaging designee for the instant messaging session, wherein the designee setting information is generated by the designator-side device after the designator-side device selects at least one of the contacts in the contact list to serve as the messaging object that corresponds to an instant messaging device serving as an object-side device, and selects at least one of the contacts in the contact list that is other than the messaging object to serve as the messaging designee that corresponds to an instant messaging device serving as a designee-side device; and, by the instant messaging server, activating a deputy mode for the designator-side device, the designee-side device and the object-side device with respect to the instant messaging session by generating a designee setting notification based on the designee setting information and transmitting the designee setting notification to the designee-side device, wherein the designee setting notification indicates that a user of the designee-side device has been selected by the user of the designator-side messaging device to be the messaging designee for messaging with the messaging object in the instant messaging session. When the deputy mode has been activated and when the instant messaging server receives a designee-to-object message which is transmitted by the designee-side device and which is directed to the object-side device, the instant messaging server, based on the designee setting information, transmits the designee-to-object message to the object-side device in a name of the designator-side device instantly, and transmits the designee-to-object message to the designator-side device instantly.

An object of the disclosure is to provide an instant messaging device that serves as the designator-side device in the method of this disclosure.

According to the disclosure, the instant messaging device is capable of performing instant messaging with multiple instant messaging devices through an instant messaging server, and includes a storage unit, a communication interface, a processing unit and an input-and-output (I/O) interface. The storage unit stores an instant messaging software program therein. The communication interface is communicatively coupled to the instant messaging server. The processing unit is coupled to the storage unit for reading and executing the instant messaging software program, is coupled to the communication interface for connection to the instant messaging server, and is operable to establish, through the instant messaging software program, a contact list which has a plurality of contacts of a user. The I/O interface is coupled to the processing unit. The processing unit is configured to, based on input operation on the I/O interface: (i) select at least one of the contacts in the contact list to serve as a messaging object that corresponds to an instant messaging device serving as an object-side device, (ii) select at least one of the contacts in the contact list that is other than the messaging object to serve as a messaging designee that corresponds to an instant messaging device serving as a designee-side device, and (iii) transmit designee setting information that indicates the messaging object and the messaging designee to the instant messaging server via the communication interface, such that the instant messaging server activates a deputy mode for the instant messaging device serving as a designator-side device, the designee-side device and the object-side device with respect to an instant messaging session between said designator-side device and the object-side device by generating a designee setting notification based on the designee setting information and transmitting the designee setting notification to the designee-side device. The designee setting notification indicates that a user of the designee-side device has been selected by a user of the designator-side messaging device to be the messaging designee for messaging with the messaging object in the instant messaging session. In the deputy mode, when the designee-side device transmits, to the instant messaging server, a designee-to-object message which is directed to the object-side device, the instant messaging server, based on the designee setting information, transmits the designee-to-object message to the object-side device in a name of the designator-side device instantly, and transmits the designee-to-object message to the designator-side device instantly.

An object of the disclosure is to provide an instant messaging device that serves as the designee-side device in the method of this disclosure.

According to the disclosure, the instant messaging device is capable of performing instant messaging with multiple instant messaging devices through an instant messaging server, and includes a storage unit, a communication interface, a processing unit and an input-and-output (I/O) interface. The storage unit stores an instant messaging software program therein. The communication interface is communicatively coupled to the instant messaging server for receiving a designee setting notification from the instant messaging server, wherein the designee setting notification indicates that a user of the instant messaging device has been selected by a user of a designator-side device to be a messaging designee for messaging with a messaging object that corresponds to an object-side device in an instant messaging session between the designator-side device and the object-side device, such that the instant messaging device serves as a designee-side device. The designee setting notification is generated by the instant messaging server when the instant messaging server receives designee setting information from the designator-side device. The designee setting information indicates the messaging object, and the user being selected as the messaging designee. The processing unit is coupled to the storage unit for reading and executing the instant messaging software program, is coupled to the communication interface for receiving the designee setting notification, and is configured to operate in a deputy mode that is activated by the instant messaging server for the designator-side device, the designee-side device and the object-side device with respect to an instant messaging session between the designator-side device and the object-side device. The I/O interface is coupled to the processing unit. The processing unit is configured to, based on input operation on the I/O interface, generate a designee-to-object message which is directed to the object-side device in the deputy mode, and transmit the designee-to-object message to the instant messaging server via the communication interface, such that the instant messaging server, based on the designee setting information, transmits the designee-to-object message to the object-side device in a name of the designator-side device instantly, and transmits the designee-to-object message to the designator-side device instantly and simultaneously with the transmission of the designee-to-object message to the object-side device.

An object of the disclosure is to provide an instant messaging server in the method of this disclosure.

According to the disclosure, the instant messaging server is provided for enabling instant messaging among a plurality of instant messaging devices, and includes a communication interface, a storage unit and a processing unit. The communication interface is communicatively coupled to the instant messaging devices, and is disposed to receive designee setting information from one of the instant messaging devices that is user by a messaging designator and that serves as a designator-side device. The designee setting information indicates a messaging object that corresponds to at least another one of the instant messaging devices which serves as an object-side device, and a messaging designee that corresponds to at least yet another one of the instant messaging devices which serves as a designee-side device. The storage unit is for storing the designee setting information. The processing unit is coupled to the communication interface and the storage unit, and is configured to activate a deputy mode for the designator-side device, the designee-side device and the object-side device with respect to an instant messaging session between the designator-side device and the object-side device by generating a designee setting notification based on the designee setting information, and transmitting the designee setting notification to the designee-side device via the communication interface. The designee setting notification indicates that a user of the designee-side device has been selected by a user of the designator-side messaging device to be the messaging designee for messaging with the messaging object in the instant messaging session. The processing unit is configured to, when the deputy mode has been activated and when the processing unit receives, via the communication interface, a designee-to-object message which is transmitted by the designee-side device and which is directed to the object-side device, based on the designee setting information, transmit the designee-to-object message to the object-side device in a name of the designator-side device instantly via the communication interface, and transmit the designee-to-object message to the designator-side device instantly via the communication interface.

### BRIEF DESCRIPTION OF THE DRAWINGS

Other features and advantages of the disclosure will become apparent in the following detailed description of the embodiment (s) with reference to the accompanying drawings, of which:

FIG. 1 is a flow chart illustrating an embodiment of the method of setting a designee in instant messaging according to the disclosure;

FIG. 2 is a block diagram illustrating that multiple instant messaging devices perform instant messaging through an instant messaging server in this embodiment;

FIG. 3 is a block diagram illustrating the instant messaging devices and the instant messaging server in this embodiment;

FIG. 4 is schematic diagram exemplarily illustrating a contact list screen in this embodiment;

FIG. 5 is a schematic diagram exemplarily illustrating a messaging screen displayed by a designator-side device in this embodiment; and

FIG. 6 is a schematic diagram exemplarily illustrating a function menu screen in this embodiment;

FIG. 7 is schematic diagram exemplarily illustrating a chat setting screen in this embodiment;

FIG. 8 is a schematic diagram exemplarily illustrating a designee setting screen in this embodiment;

FIGS. 9 and 10 are schematic diagrams illustrating messaging screens respectively displayed by the designator-side device and an object-side device in this embodiment when a deputy mode has been activated;

FIGS. 11, 12 and 13 are schematic diagrams illustrating messaging screens respectively displayed by the designator-side device, the object-side device and a designee-side device in this embodiment when the designator-side device is operated to send a message to the designee-side device;

FIGS. 14, 15 and 16 are schematic diagrams illustrating messaging screens respectively displayed by the designator-side device, the object-side device and the designee-side device in this embodiment when the designee-side device is operated to send a message to the designator-side device;

FIGS. 17, 18 and 19 are schematic diagrams illustrating messaging screens respectively displayed by the designator-side device, the object-side device and the designee-side device in this embodiment when the designator-side device is operated to send a message to the object-side device; and

FIGS. 20, 21 and 22 are schematic diagrams illustrating messaging screens respectively displayed by the designator-side device, the object-side device and the designee-side device in this embodiment when the designee-side device is operated to send a message to the object-side device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

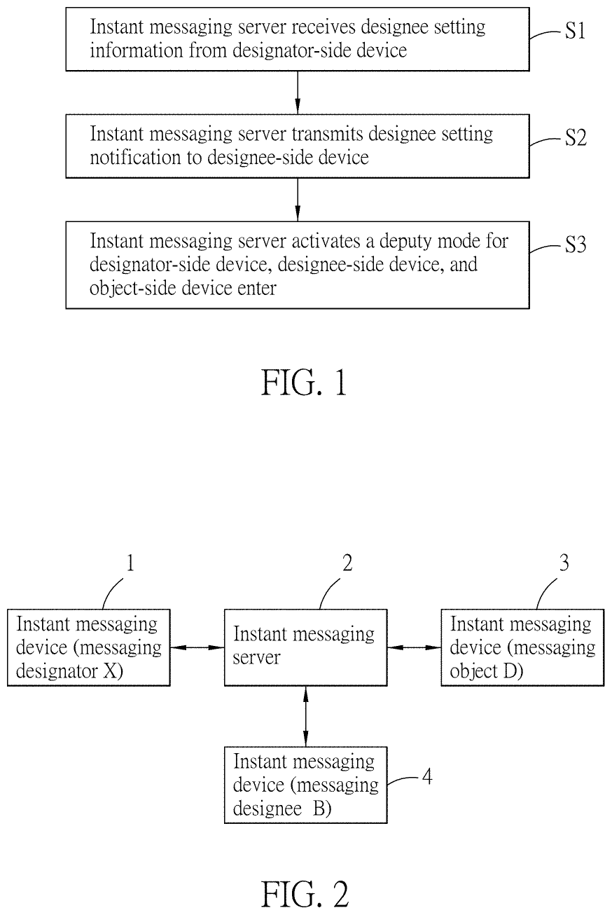

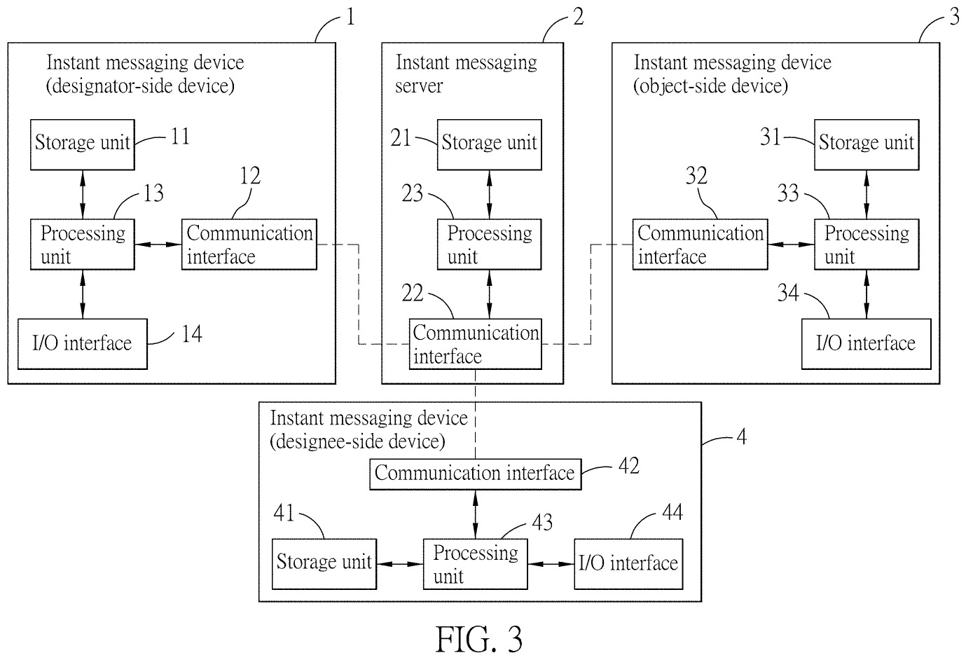

Referring to FIG. 1, the embodiment of the method of setting a designee for a user in an instant messaging session is proposed. As used herein, the term “designee” refers to someone that the user designates as a deputy of the user to act on behalf of the user with respect to the particular instant messaging session. In an exemplary implementation as shown in FIG. 2, instant messaging is performed by instant messaging devices 1, 3, 4 that are respectively used by users (X, D, B) and that communicate with each other through an instant messaging server 2. Each of the instant messaging devices 1, 3, 4 may be a smartphone, a tablet computer, a notebook computer, a desktop computer, or the like, which is capable of connecting to a network so as to perform instant messaging with multiple other instant messaging devices via the instant messaging server 2. Further referring to FIG. 3, each of the instant messaging device 1, 3, 4 includes a storage unit 11, 31, 41 (e.g., a hard disk drive, a solid state drive, flash memory, etc.) in which an instant messaging software program is stored, a communication interface 12, 32, 42 (e.g., a network card, a Wi-Fi module, etc.) for communication with the instant messaging server 2 via the network, a processing unit 13, 33, 43 (e.g., a single core processor, a multi-core processor, etc.), and an input-and-output (I/O) interface 14, 34, 44 (e.g., including a keyboard and a display, a touchscreen, etc.), where the processing unit 13, 33, 43 is coupled to the storage unit 11, 31, 41, the communication interface 12, 32, 42 and the I/O interface 14, 34, 44. The instant messaging server 2 includes a storage unit 21, a communication interface 22 for communication with the communication interfaces 12, 32, 42 of the instant messaging device 1, 3, 4, and a processing unit 23 coupled to the storage unit 21 and the communication interface 22.

In this implementation, it is exemplified that the user (X) is one who uses the embodiment to designate the user (B) as a designee (of the user (X)) in an instant messaging session with the user (D) (i.e., an instant messaging session between the users (X) and (B), hereinafter also referred to as “the subject instant messaging session”). Instant messaging is performed through the instant messaging software programs that are stored in and executed by the instant messaging devices 1, 3, 4, respectively.

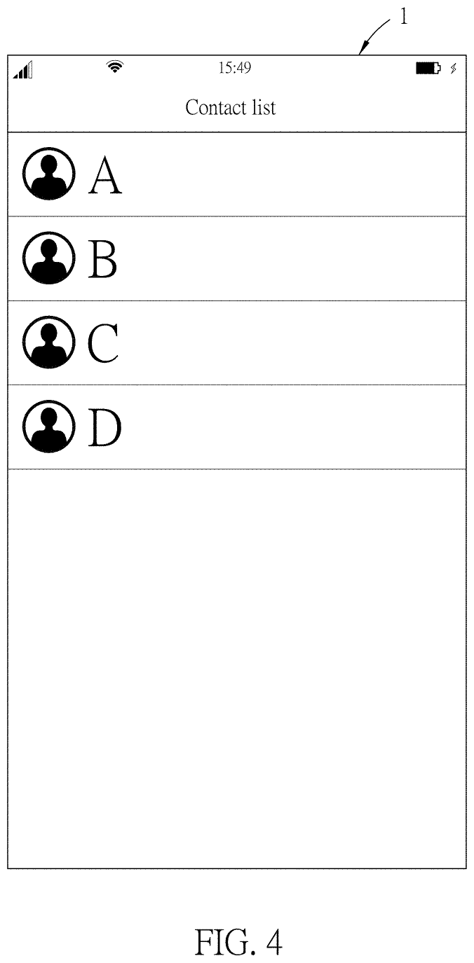

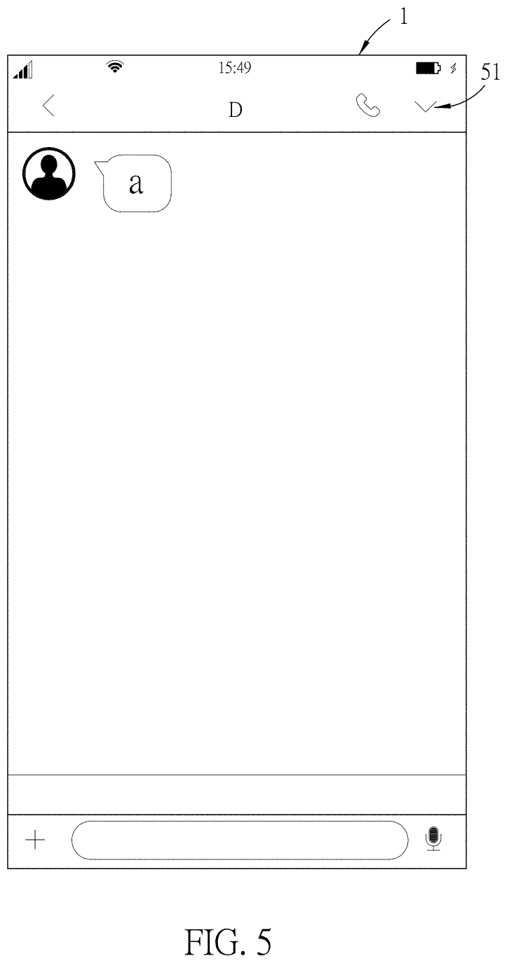

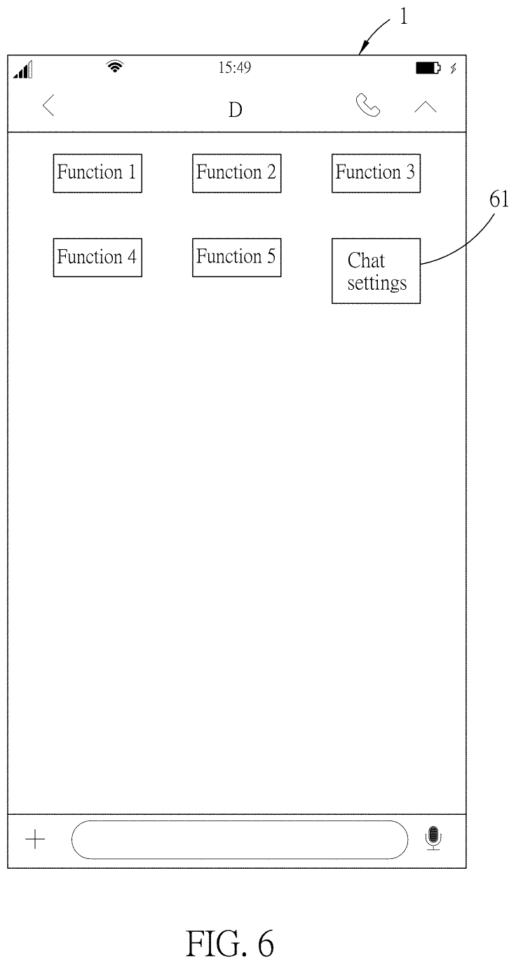

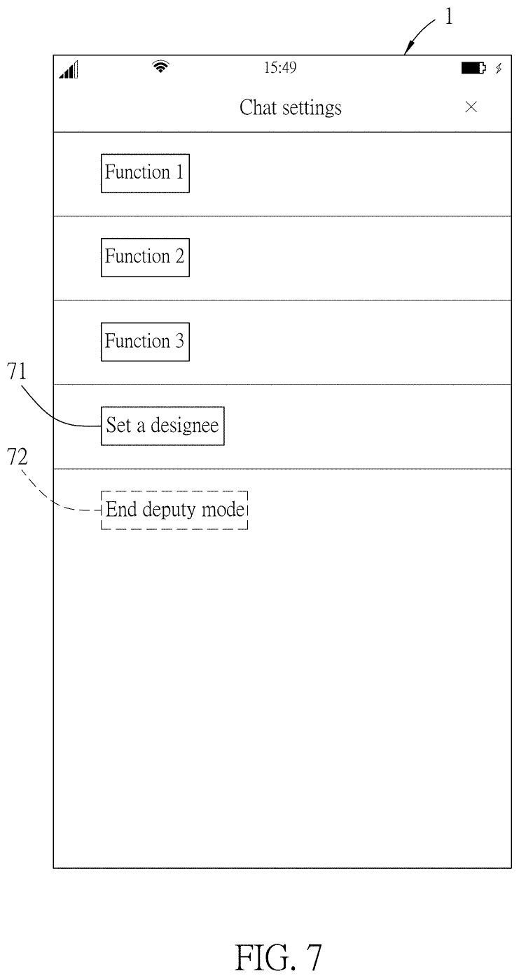

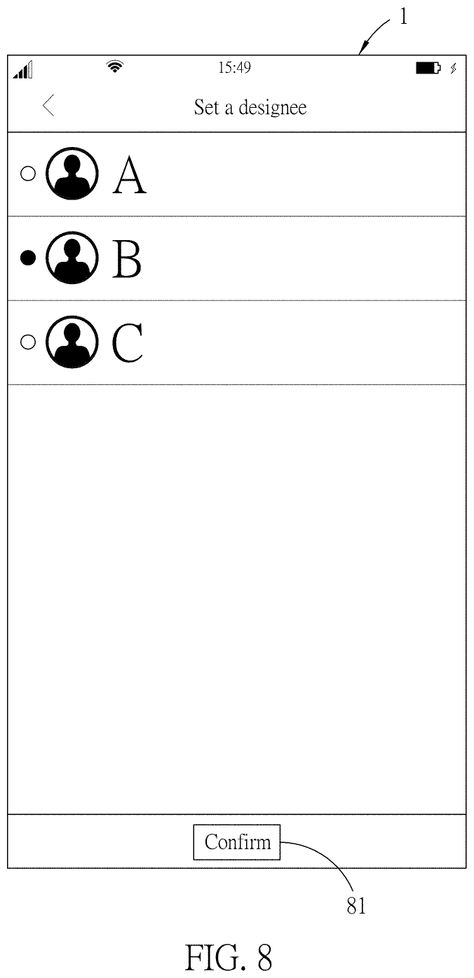

When the processing unit 13 of the instant messaging device 1 executes the instant messaging software program stored in the storage unit 11, the user (X) may operate the I/O interface 14 to cause the processing unit 13 to open a contact list of the user (X). The contact list is pre-established by the processing unit 13 that executes the instant messaging software program, is stored in the storage unit 11, and has a plurality of contacts of the user (X), which include the user (B) and the user (D) that respectively correspond to the instant messaging devices 3, 4. FIG. 4 exemplarily shows a contact list screen displayed by the instant messaging device 1 after the contact list is opened. The contact list screen allows the user (X) to select, by operating the I/O interface 14, at least one of the contacts to serve as a messaging object with whom the user (X) would like to communicate in an instant messaging session. In this embodiment, the user (D) is exemplified as the messaging object (referred to as “messaging object (D)” hereinafter), and the instant messaging device 3 that corresponds to the messaging object (D) is referred to as “object-side device 3” hereinafter. It is noted that the instant messaging session may be held with two or more messaging objects in other embodiments, and this disclosure is not limited in this respect. After the user (D) is selected from the contact list, the processing unit 13 that executes the instant messaging software program to open a messaging screen which is displayed by the I/O interface 14 and which is associated with the messaging object (D), as exemplified in FIG. 5, where the left side of the messaging screen shows a message “a”, which was sent by the messaging object (D) via the object-side device 3. Once the messaging screen associated with the messaging object (D) is opened, the user (X) may trigger (e.g., by clicking, pressing, etc.) a function mark 51 in the messaging screen, such that the processing unit 13 causes the I/O interface 14 to display a function menu screen, as exemplified in FIG. 6. When an option 61 of “Chat settings” in the function menu screen is triggered, the processing unit 13 causes the I/O interface 14 to display a chat setting screen as exemplified in FIG. 7. When an option 71 of “Seta designee” in the chat setting screen is triggered, the processing unit 13 causes the I/O interface 14 to display a designee setting screen, as exemplified in FIG. 8. The designee setting screen shows contacts in the contact list except for the user (D), which has already been chosen as the messaging object.

In the designee setting screen, the user (X) may operate the I/O interface 14 of the instant messaging device 1 to select at least one of the displayed contacts (i.e., those other than the messaging object (D)) to serve as a messaging designee who is allowed to send messages in the name of the user (X) in the subject instant messaging session with the messaging object (D). In this implementation, it is exemplified that the user (B) is selected (see that a dot beside the name “B” in FIG. 8 is black-filled, representing that the user (B) has been selected) as the messaging designee (referred to as “messaging designee (B)” hereinafter), and the instant messaging device 4 that corresponds to the messaging designee (B) is referred to as “designee-side device 4” hereinafter. It is noted that two or more messaging designees may be set for one instant messaging session in other embodiments, and this disclosure is not limited in this respect. Accordingly, the user (X) serves as a messaging designator (referred to as “messaging designator (X)” hereinafter) in this implementation, indicating that the user (X) is the one who assigns the designee in the subject instant messaging session, and the instant messaging device 1 that corresponds to the messaging designator (X) is referred to as “designator-side device 1” hereinafter. After a confirm button 81 in the designee setting screen is triggered, the processing unit 13 generates designee setting information that indicates the messaging object (D) and the messaging designee (B) (i.e., indicating that the instant messaging device 3 that corresponds to the messaging object (D) serves as the object-side device for the instant messaging device 1 in the instant messaging session between the messaging object (D) and the messaging designator (X), and the instant messaging device 4 that corresponds to the messaging designee (B) serves as the designee-side device for the instant messaging device 1 in the instant messaging session between the messaging object (D) and the messaging designator (X)), and transmits the designee setting information to the instant messaging server 2 via the communication interface 12 (step S1, see FIG. 1). It is noted that the messaging object (D) may be a single contact of the user, or a group including multiple contacts.

Referring to FIGS. 2 and 3, upon receipt of the designee setting information from the designator-side device 1 via the communication interface 22, the processing unit 23 stores the designee setting information in the storage unit 21, and starts a procedure for activating a deputy mode for the designator-side device 1, the object-side device 3 and the designee-side device 4 with respect to the subject instant messaging session by generating a designee setting notification based on the designee setting information, and transmitting the designee setting notification to the designee-side device 4 (step S2, see FIG. 1). The designee setting notification indicates that the user (B) of the instant messaging device 4 has been selected by the designator-side device 1 to be a messaging designee for messaging with the messaging object (D).

Upon receipt of the designee setting notification via the communication interface 42, the processing unit 43 that executes the instant messaging software program stored in the storage unit 41 may generate an accepting notification based on an operation of the user (B) on the I/O interface 44 to accept the designee setting notification, and transmit the accepting notification to the designator-side device 1 via the communication interface 42 and the instant messaging server 2, allowing the instant messaging server 2 to activate the deputy mode for the designator-side device 1, the object-side device 3 and the designee-side device 4 with respect to the subject instant messaging session (step S3, see FIG. 1). After the designator-side device 1 receives the accepting notification, the processing units 13, 43 that execute the instant messaging software programs respectively stored in the storage units 11, 41 operate in the deputy mode. In other embodiments, the instant messaging server 2 may activate the deputy mode after the user (B) operates the instant messaging device 4 to accept the designee setting notification or after the instant messaging device 4 receives the designee setting notification, and it is not necessary for the designee-side device 4 to transmit the accepting notification to the designator-side device 1 via the instant messaging server 2.

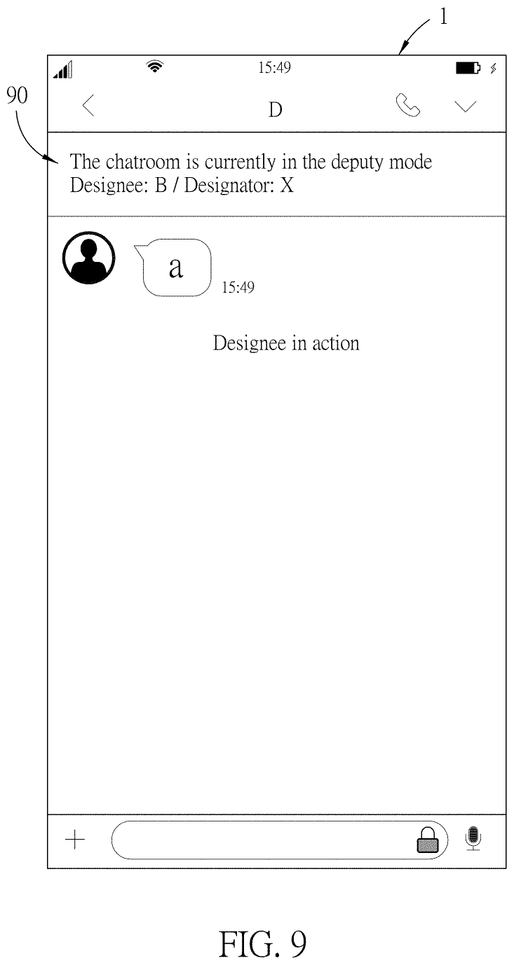

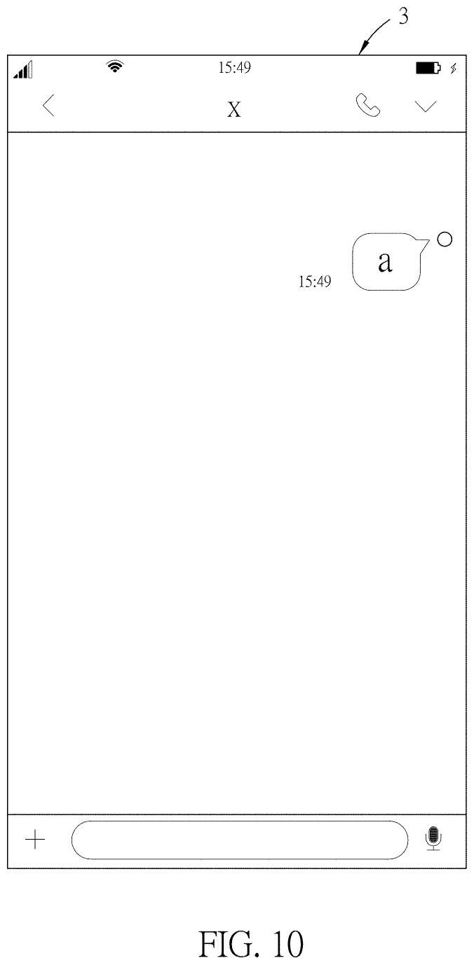

FIG. 9 exemplarily illustrates a messaging screen that is displayed by the designator-side device 1 for the instant messaging session with the messaging object (D) after the deputy mode has been activated and that shows a message 90 indicating that the subject instant messaging session is under the deputy mode, and a message “Designee in action”, meaning that the designee has begun to act on behalf of the user (designator) with respect to the instant messaging session between the user and the messaging object. FIG. 10 exemplarily illustrates a messaging screen that is displayed by the object-side device 3 for messaging with the user (X) after the deputy mode has been activated and that does not show any messages relating to the deputy mode. Accordingly, the messaging object (D) is unaware that the user (B) will serve as a designee of the user (A) in the subject instant messaging session.

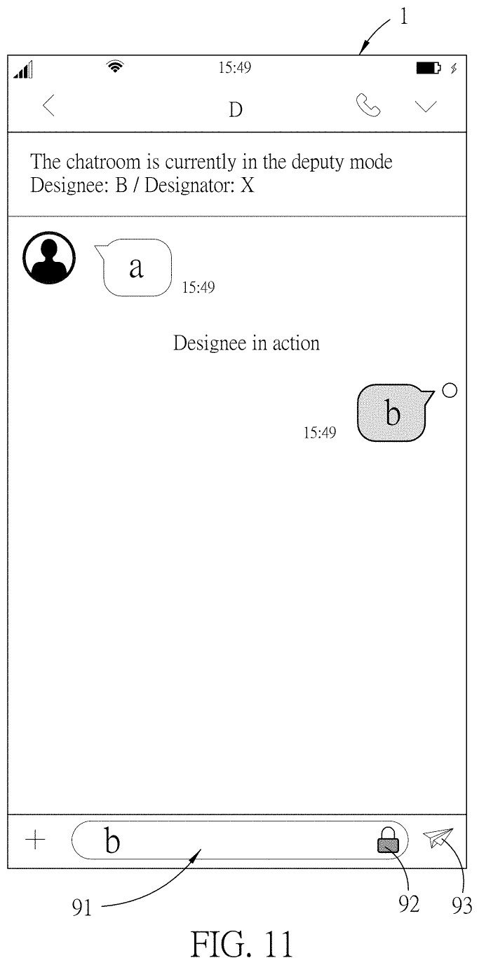

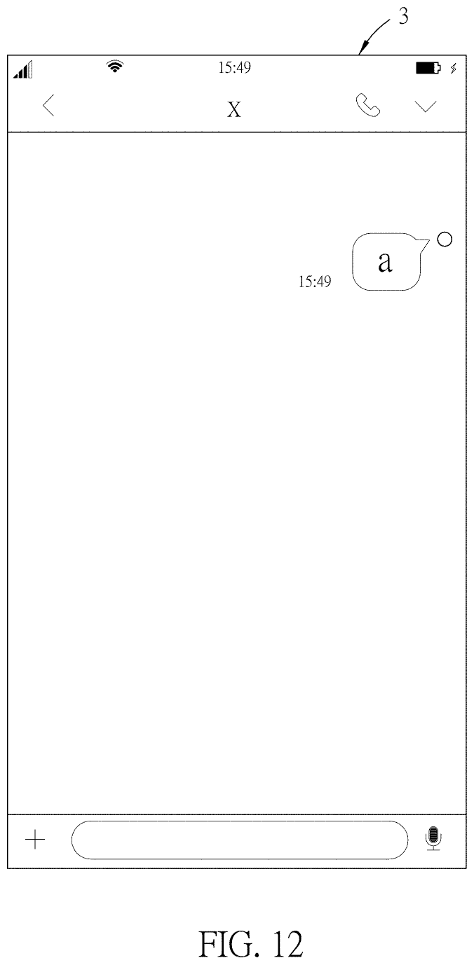

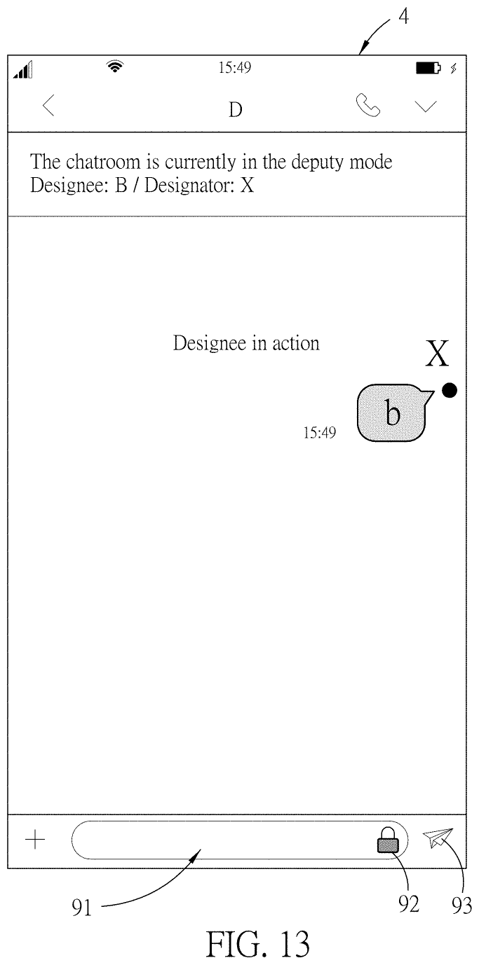

In the deputy mode, each of the designator-side device 1 and the designee-side device 4 is selectable by the corresponding user (X) or (B) to operate in an open mode or a whisper mode. When the processing unit 13 (or 43) executes the instant messaging software program in the open mode, messages sent by the designator-side device 1 (or the designee-side device 4) will be open to the object-side device 3, such that the object-side device 3 will display these messages in the messaging screen for the subject instant messaging session; and, when the processing unit 13 (or 43) executes the instant messaging software program in the whisper mode, messages sent by the designator-side device 1 (or the designee-side device 4) will be hidden from the object-side device 3, such that the object-side device 3 will not display these messages. The processing unit 13, 43 controls the I/O interface 14, 44 to provide a first option corresponding to the open mode and a second option corresponding to the whisper mode for the user (X, B) to selectively execute one of the first and second options in the deputy mode. FIGS. 11, 12 and 13 illustrate messaging screens respectively displayed by the designator-side device 1, the object-side device 3, and the designee-side device 4 when the designator-side device 1 sends a message to the designee-side device 4 in the whisper mode. As illustrated in FIG. 11, a lock pattern 92 is shown in an input field 91 of the messaging screen, meaning that the second option is selected. Therefore, further referring to FIGS. 2 and 3, the processing unit 13 generates, according to what is inputted in the input field 91, a designator-to-designee message (exemplified as “b” in the example illustrated by FIGS. 11 to 13) that is directed to the designee-side device 4, and transmits, upon a pattern 93 for sending messages is triggered, the designator-to-designee message to the instant messaging server 2 via the communication interface 12. Upon receipt of the designator-to-designee message via the communication interface 22, the processing unit 23 of the instant messaging server 2 transmits, based on the designee setting information indicating that the instant messaging device 4 serves as the designee-side device in the subject instant messaging session, the designator-to-designee message to the designee-side device 4 instantly via the communication interface 22. Accordingly, the messaging screen displayed by the object-side device 3 does not show the designator-to-designee message “b”, as illustrated in FIG. 12, and the messaging screen displayed by the designee-side device 4 shows the designator-to-designee message “b” as illustrated in FIG. 13.

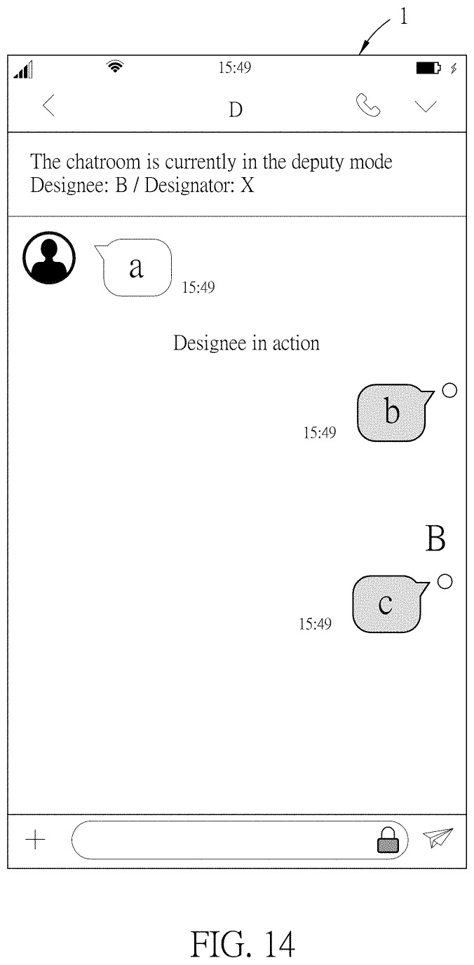

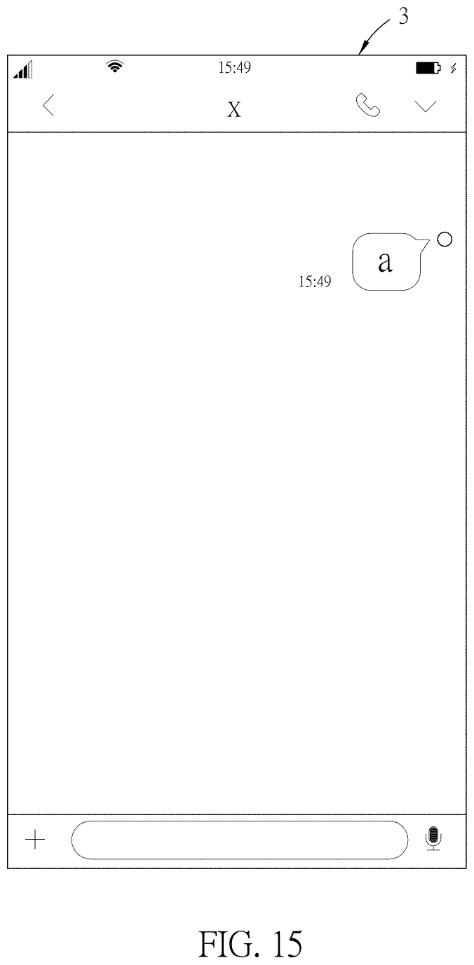

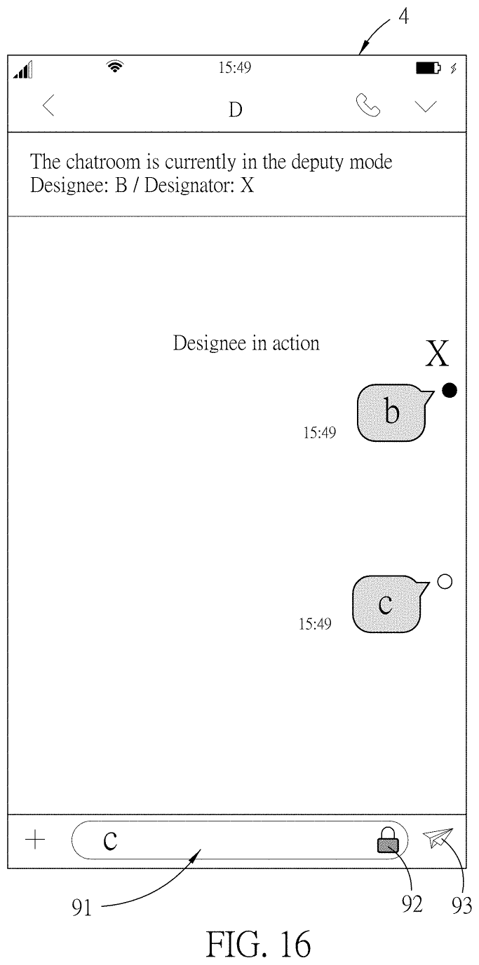

FIGS. 14, 15 and 16 illustrate messaging screens respectively displayed by the designator-side device 1, the object-side device 3, and the designee-side device 4 when the designee-side device 4 sends a message to the designator-side device 1 in the whisper mode. As illustrated in FIG. 16, the lock pattern 92 is shown in the input field 91 of the messaging screen, meaning that the second option is selected. Therefore, further referring to FIGS. 2 and 3, the processing unit 43 generates, according to what is inputted in the input field 91, a designee-to-designator message (exemplified as “c” in the example illustrated by FIGS. 14 to 16) that is directed to the designator-side device 1, and transmits, upon a pattern 93 for sending messages is triggered, the designee-to-designator message to the instant messaging server 2 via the communication interface 42. Upon receipt of the designee-to-designator message via the communication interface 22, the processing unit 23 of the instant messaging server 2 transmits, based on the designee setting information indicating that the instant messaging device 4 serves as the designee-side device in the subject instant messaging session, the designee-to-designator message to the designator-side device 1 instantly via the communication interface 22. Accordingly, the messaging screen displayed by the object-side device 3 does not show the designee-to-designator message “c”, as illustrated in FIG. 15, and the messaging screen displayed by the designator-side device 1 shows the designee-to-designator message “c” as illustrated in FIG. 14.

As a result, the messaging designee (B) and the messaging designator (X) can send messages to each other in the whisper mode while the messaging object (D) is unaware of it.

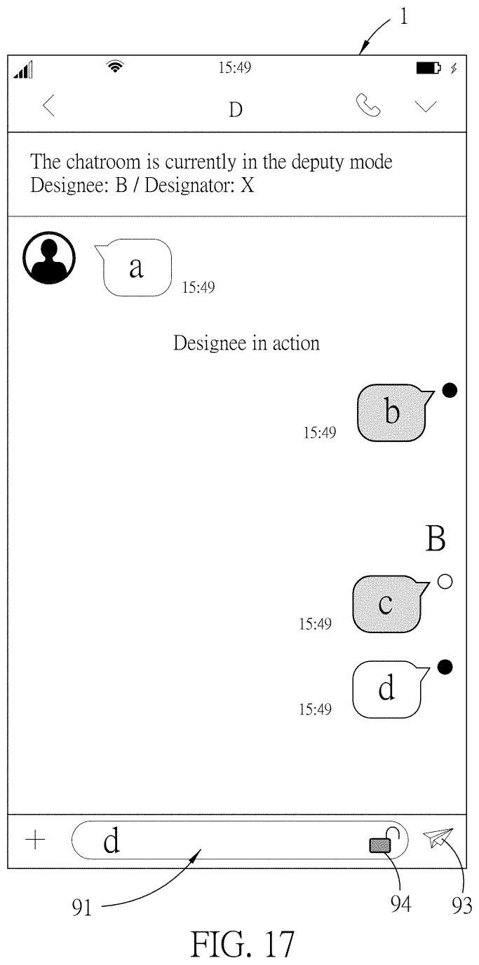

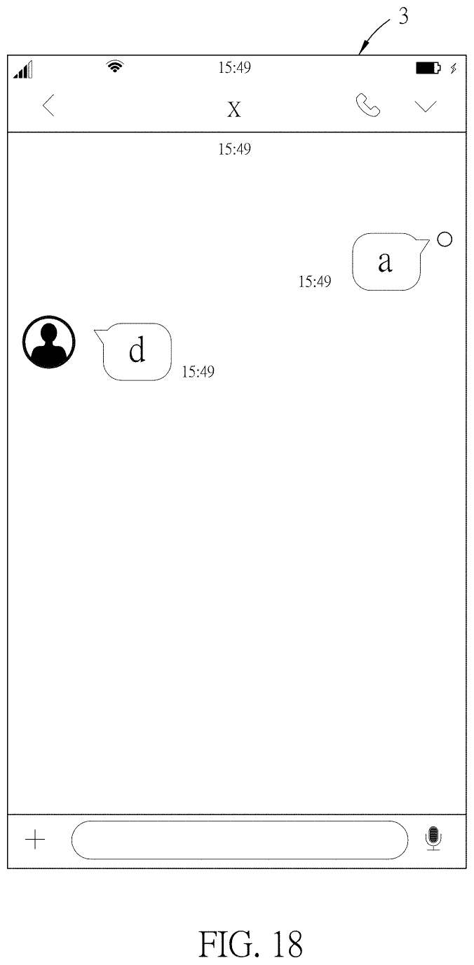

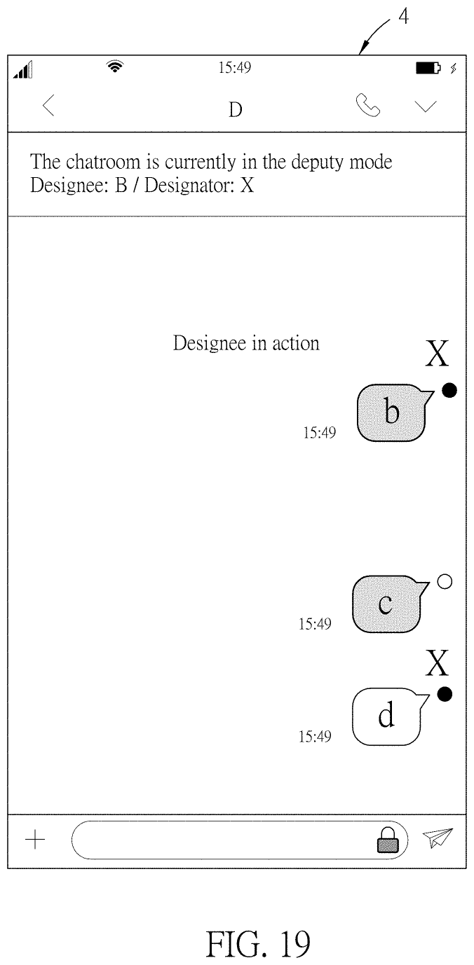

FIGS. 17, 18 and 19 illustrate messaging screens respectively displayed by the designator-side device 1, the object-side device 3, and the designee-side device 4 when the designator-side device 1 sends a message to the object-side device 3 in the open mode. As illustrated in FIG. 17, an unlock pattern 94 is shown in the input field 91 of the messaging screen, meaning that the first option is selected. It is noted that the lock pattern 92 (second option, see FIG. 11) may be changed to the unlock pattern 94 (first option) when triggered by the user, and vice versa, so as to switch operation between the whisper mode and the open mode. In other embodiments, the lock pattern 92 and the unlock pattern 94 may be shown in the input field 91 at the same for selection by the user, or the lock pattern 92 and the unlock pattern 94 may be shown after the pattern 93 for sending messages is triggered, and this disclosure is not limited in this respect. Further referring to FIGS. 2 and 3, the processing unit 13 generates, according to what is inputted in the input field 91, a designator-to-object message (exemplified as “d” in the example illustrated by FIGS. 17 to 19) that is directed to the object-side device 3, and transmits, upon the pattern 93 for sending messages is triggered, the designator-to-object message to the instant messaging server 2 via the communication interface 12. Upon receipt of the designator-to-object message via the communication interface 22, the processing unit 23 of the instant messaging server 2 transmits, based on the designee setting information indicating that the instant messaging device 3 serves as the object-side device in the subject instant messaging session and the instant messaging device 4 serves as the designee-side device in the subject instant messaging session, the designator-to-object message to both of the object-side device 3 and the designee-side device 4 instantly and simultaneously via the communication interface 22. Accordingly, the messaging screen displayed by the object-side device 3 shows the designator-to-object message “d”, as illustrated in FIG. 18, and the messaging screen displayed by the designee-side device 4 shows the designator-to-object message “d” as illustrated in FIG. 19. However, the messaging object (D) is unaware that the message “d” is also sent to the messaging designee (B) at the same time.

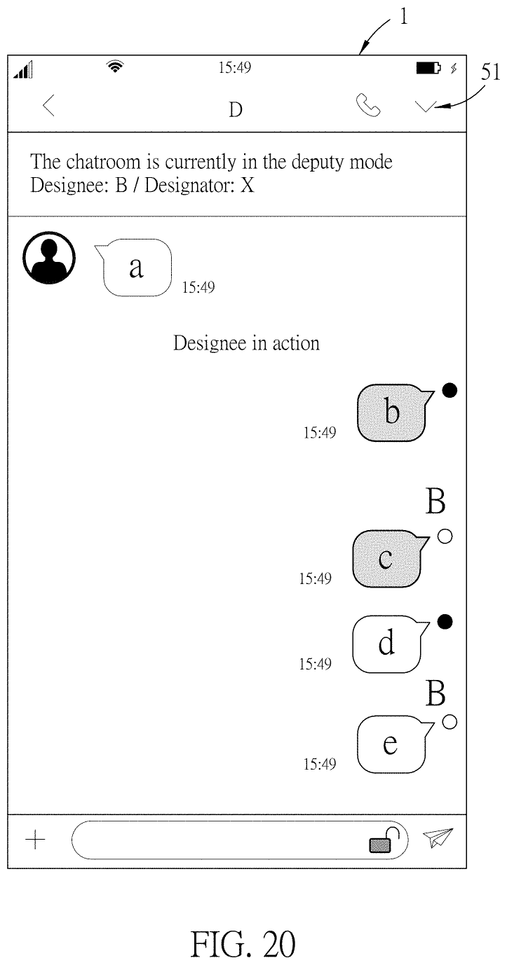

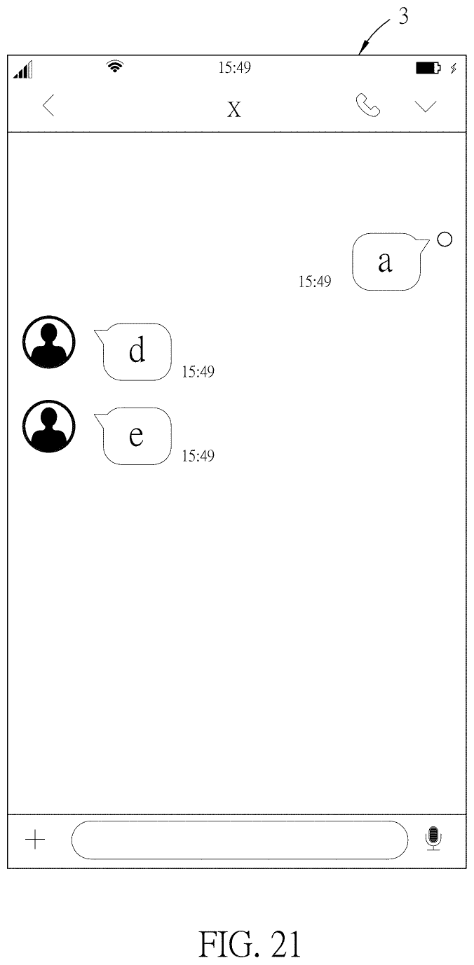

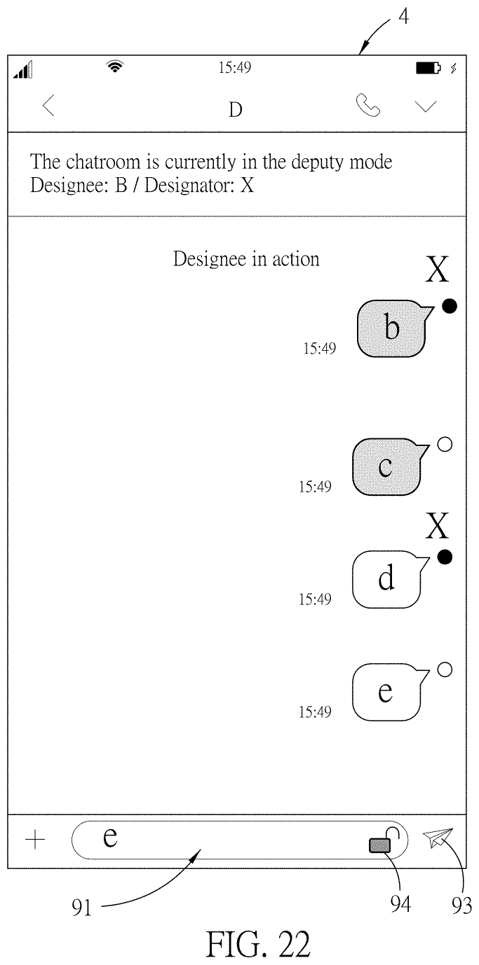

FIGS. 20, 21 and 22 illustrate messaging screens respectively displayed by the designator-side device 1, the object-side device 3, and the designee-side device 4 when the designee-side device 4 sends a message to the object-side device 3 in the open mode. As illustrated in FIG. 22, the unlock pattern 94 is shown in the input field 91 of the messaging screen, meaning that the first option is selected. Therefore, further referring to FIGS. 2 and 3, the processing unit 43 generates, according to what is inputted in the input field 91, a designee-to-object message (exemplified as “e” in the example illustrated by FIGS. 22 to 22) that is directed to the object-side device 3, and transmits, upon the pattern 93 for sending messages is triggered, the designee-to-object message to the instant messaging server 2 via the communication interface 42. Upon receipt of the designee-to-object message via the communication interface 22, the processing unit 23 of the instant messaging server 2, based on the designee setting information indicating that the instant messaging device 3 serves as the object-side device in the subject instant messaging session and the instant messaging device 4 serves as the designee-side device in the subject instant messaging session, transmits the designee-to-object message to the object-side device 3 in the name of the designator-side device 1 via the communication interface 22, and transmits the designee-to-object message to the designator-side device 1 instantly and simultaneously via the communication interface 22. Accordingly, the messaging screen displayed by the object-side device 3 shows the designee-to-object message “e”, as illustrated in FIG. 21, and the messaging screen displayed by the designator-side device 1 shows the designee-to-object message “e” as illustrated in FIG. 20. In this way, the messaging object (D) will suppose that the message “e” came from the messaging designator (X) and will not be aware that the message “e” was actually sent by the messaging designee (B).

Moreover, upon receipt via the communication interface 22 of an object-to-designator message that is transmitted by the object-side device 3 and that is directed to the designator-side device 1, the processing unit 23 of the instant messaging server 2 transmits, based on the designee setting information indicating that the instant messaging device 4 serves as the designee-side device in the subject instant messaging session, the object-to-designator message to both of the designator-side device 1 and the designee-side device 4 instantly and simultaneously via the communication interface 22.

When the messaging designator (X) wishes to end the deputy mode, the messaging designator (X) may, as exemplified in FIG. 20, trigger the function mark 51 in the messaging screen, and the processing unit 13 controls the I/O interface 14 to display the function menu screen, as shown in FIG. 6. Then, when the option 61 of “Chat settings” in the function menu screen is triggered, the processing unit 13 causes the I/O interface 14 to display the chat setting screen as exemplified in FIG. 7. At this time, the chat setting screen shows an option 72 of “End deputy mode”, which is only shown when the instant messaging device is in the deputy mode. When the option 72 is triggered, the processing unit 13 deactivates the deputy mode by transmitting an ending notification to the designee-side device 4 through the instant messaging server 2, causing the instant messaging device 4 to end the destination mode and causing the instant messaging server 2 to remove the designee setting information from the storage unit 21.

By virtue of setting the messaging designee through the instant messaging server, the messaging designee can reply to the messaging object in the name of the messaging designator, such that the messaging object may receive required responses instantly even if the messaging designator is unable to send messages. In the instant messaging session where the messaging designator and the messaging designee send messages in the open mode, each of the messaging designator and the messaging designee can not only receive messages from the messaging object, but can also receive messages that are sent to the messaging object by the other one of the messaging designator and the messaging designee. Accordingly, the messaging designator (X) and/or the messaging designee (B) may reply to questions from or have discussions with the messaging object (D) instantly in an appropriate way with reference to messages exchanged between the messaging designator (X) and the messaging designee (B). In addition, the messaging designator (X) and the messaging designee (B) can use the whisper mode to send messages to each other secretly, so as to ensure that responses made to the messaging object (D) are appropriate.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of setting a designee for a user who uses an instant messaging device serving as a designator-side device in an instant messaging session, the designator-side device corresponding to a contact list which has a plurality of contacts of the user, and being configured to perform instant messaging with multiple instant messaging devices through an instant messaging server, said method comprising:
by the instant messaging server, receiving, from the designator-side device, designee setting information that indicates a messaging object and a messaging designee for the instant messaging session, wherein the designee setting information is generated by the designator-side device after the designator-side device selects at least one of the contacts in the contact list to serve as the messaging object that corresponds to an instant messaging device serving as an object-side device, and selects at least one of the contacts in the contact list that is other than the messaging object to serve as the messaging designee that corresponds to an instant messaging device serving as a designee-side device; and
by the instant messaging server, activating a deputy mode for the designator-side device, the designee-side device and the object-side device with respect to the instant messaging session by generating a designee setting notification based on the designee setting information and transmitting the designee setting notification to the designee-side device, wherein the designee setting notification indicates that a user of the designee-side device has been selected by the user of the designator-side messaging device to be the messaging designee for messaging with the messaging object in the instant messaging session;
wherein, when the deputy mode has been activated, when the instant messaging server receives a designee-to-object message which is transmitted by the designee-side device and which is directed to the object-side device, the instant messaging server, based on the designee setting information, transmits the designee-to-object message to the object-side device in a name of the designator-side device instantly, and transmits the designee-to-object message to the designator-side device instantly.

2. The method of claim 1, wherein, in the deputy mode, when the instant messaging server receives a designator-to-object message which is transmitted by the designator-side device and which is directed to the object-side device, the instant messaging server transmits, based on the designee setting information, the designator-to-object message to both of the object-side device and the designee-side device instantly.

3. The method of claim 2, wherein, in the deputy mode, when the instant messaging server receives a designator-to-designee message which is transmitted by the designator-side device and which is directed to the designee-side device, the instant messaging server transmits, based on the designee setting information, the designator-to-designee message to the designee-side device instantly.

4. The method of claim 1, wherein, in the deputy mode, when the instant messaging server receives a designee-to-designator message which is transmitted by the designee-side device and which is directed to the designator-side device, the instant messaging server transmits, based on the designee setting information, the designee-to-designator message to the designator-side device instantly.

5. The method of claim 1, wherein, in the deputy mode, when the instant messaging server receives an object-to-designator message which is transmitted by the object-side device and which is directed to the designator-side device, the instant messaging server transmits, based on the designee setting information, the object-to-designator message to both of the designator-side device and the designee-side device instantly.

6. The method of claim 1, wherein the instant messaging server activates the deputy mode after transmitting an accepting notification, which is received from the designee-side device and which is generated by the designee-side device accepting the designee setting notification, to the designator-side device.

7. An instant messaging device capable of performing instant messaging with multiple instant messaging devices through an instant messaging server, comprising:
a storage unit storing an instant messaging software program therein;
a communication interface communicatively coupled to the instant messaging server;
a processing unit coupled to said storage unit for reading and executing the instant messaging software program, coupled to said communication interface for connection to the instant messaging server, and operable to establish, through the instant messaging software program, a contact list which has a plurality of contacts of a user; and
an input-and-output (I/O) interface coupled to said processing unit, wherein said processing unit is configured to, based on input operation on said I/O interface:
select at least one of the contacts in the contact list to serve as a messaging object that corresponds to an instant messaging device serving as an object-side device,
select at least one of the contacts in the contact list that is other than the messaging object to serve as a messaging designee that corresponds to an instant messaging device serving as a designee-side device, and
transmit designee setting information that indicates the messaging object and the messaging designee to the instant messaging server via said communication interface, such that the instant messaging server activates a deputy mode for said instant messaging device serving as a designator-side device, the designee-side device and the object-side device with respect to an instant messaging session between said designator-side device and the object-side device by generating a designee setting notification based on the designee setting information and transmitting the designee setting notification to the designee-side device, wherein the designee setting notification indicates that a user of the designee-side device has been selected by a user of the designator-side messaging device to be the messaging designee for messaging with the messaging object in the instant messaging session;
wherein, in the deputy mode, when the designee-side device transmits, to the instant messaging server, a designee-to-object message which is directed to the object-side device, the instant messaging server, based on the designee setting information, transmits the designee-to-object message to the object-side device in a name of said designator-side device instantly, and transmits the designee-to-object message to said designator-side device instantly.

8. The instant messaging device of claim 7, wherein said processing unit is configured to, based on input operation on said I/O interface, generate a designator-to-object message which is directed to the object-side device in the deputy mode, and transmit the designator-to-object message to the instant messaging server via said communication interface, such that the instant messaging server transmits, based on the designee setting information, the designator-to-object message to both of the object-side device and the designee-side device instantly.

9. The instant messaging device of claim 8, wherein said processing unit is configured to, based on input operation on said I/O interface, generate a designator-to-designee message which is directed to the designee-side device in the deputy mode, and transmit the designator-to-designee message to the instant messaging server via said communication interface, such that the instant messaging server transmits, based on the designee setting information, the designator-to-designee message to the designee-side device instantly.

10. The instant messaging device of claim 9, wherein said processing unit is configured to control said I/O interface to provide a first option and a second option for the user to selectively execute one of the first and second options in the deputy mode, the first option being configured for making messages sent by said designator-side device open to the object-side device, and a second option for making messages sent by said designator-side device hidden from the object-side device;
wherein said processing unit is configured to generate the designator-to-object message and transmit the designator-to-object message to the instant messaging server via said communication interface when the first option is executed in the deputy mode, and to generate the designator-to-designee message and transmit the designator-to-designee message to the instant messaging server via said communication interface when the second option is executed in the deputy mode.

11. An instant messaging device capable of performing instant messaging with multiple instant messaging devices through an instant messaging server, comprising:
a storage unit storing an instant messaging software program therein;
a communication interface communicatively coupled to the instant messaging server for receiving a designee setting notification from the instant messaging server, wherein the designee setting notification indicates that a user of said instant messaging device has been selected by a user of a designator-side device to be a messaging designee for messaging with a messaging object that corresponds to an object-side device in an instant messaging session between the designator-side device and the object-side device, such that said instant messaging device serves as a designee-side device, the designee setting notification being generated by the instant messaging server when the instant messaging server receives designee setting information from the designator-side device, wherein the designee setting information indicates the messaging object, and the user being selected as the messaging designee;
a processing unit coupled to said storage unit for reading and executing the instant messaging software program, and coupled to said communication interface for receiving the designee setting notification, and configured to operate in a deputy mode that is activated by the instant messaging server for the designator-side device, the designee-side device and the object-side device with respect to an instant messaging session between the designator-side device and the object-side device; and
an input-and-output (I/O) interface coupled to said processing unit;
wherein said processing unit is configured to, based on input operation on said I/O interface, generate a designee-to-object message which is directed to the object-side device in the deputy mode, and transmit the designee-to-object message to the instant messaging server via said communication interface, such that the instant messaging server, based on the designee setting information, transmits the designee-to-object message to the object-side device in a name of the designator-side device instantly, and transmits the designee-to-object message the designator-side device instantly and simultaneously with the transmission of the designee-to-object message to the object-side device.

12. The instant messaging device of claim 11, wherein said processing unit is configured to, based on input operation on said I/O interface, generate a designee-to-designator message which is directed to the designator-side device in the deputy mode, and transmit the designee-to-designator message to the instant messaging server via said communication interface, such that the instant messaging server transmits, based on the designee setting information, the designee-to-designator message to the designator-side device instantly.

13. The instant messaging device of claim 12, wherein said processing unit is configured to control said I/O interface to provide a first option and a second option for the user to selectively execute one of the first and second options in the deputy mode, the first option being configured for making messages sent by said designee-side device open to the object-side device, and a second option for making messages sent by said designee-side device hidden from the object-side device;
wherein said processing unit is configured to generate the designee-to-object message and transmit the designee-to-object message to the instant messaging server via said communication interface when the first option is executed in the deputy mode, and to generate the designee-to-designator message and transmit the designee-to-designator message to the instant messaging server via said communication interface when the second option is executed in the deputy mode.

14. The instant messaging device of claim 11, wherein said instant messaging server activates the deputy mode after said processing unit transmits, in response to the designee setting notification, an accepting notification to the designator-side device via the instant messaging server, wherein the accepting notification indicates that the designee setting notification has been accepted.

15. An instant messaging server for enabling instant messaging among a plurality of instant messaging devices, comprising:
a communication interface communicatively coupled to the instant messaging devices, and disposed to receive designee setting information from one of the instant messaging devices that is used by a messaging designator and that serves as a designator-side device, wherein the designee setting information indicates a messaging object that corresponds to at least another one of the instant messaging devices which serves as an object-side device, and a messaging designee that corresponds to at least yet another one of the instant messaging devices which serves as a designee-side device;
a storage unit for storing the designee setting information; and
a processing unit coupled to said communication interface and said storage unit, and configured to activate a deputy mode for the designator-side device, the designee-side device and the object-side device with respect to an instant messaging session between the designator-side device and the object-side device by generating a designee setting notification based on the designee setting information, and transmitting the designee setting notification to the designee-side device via said communication interface, wherein the designee setting notification indicates that a user of the designee-side device has been selected by a user of the designator-side messaging device to be the messaging designee for messaging with the messaging object in the instant messaging session;
wherein said processing unit is configured to, when the deputy mode has been activated and when said processing unit receives, via said communication interface, a designee-to-object message which is transmitted by the designee-side device and which is directed to the object-side device, based on the designee setting information, transmit the designee-to-object message to the object-side device in a name of the designator-side device instantly via said communication interface, and transmit the designee-to-object message to the designator-side device instantly via said communication interface.

16. The instant messaging server of claim 15, wherein said processing unit is configured to, when the deputy mode has been activated and when said processing unit receives, via said communication interface, a designator-to-object message which is transmitted by the designator-side device and which is directed to the object-side device, transmit, based on the designee setting information, the designator-to-object message to both of the object-side device and the designee-side device instantly via said communication interface.

17. The instant messaging server of claim 16, wherein said processing unit is configured to, when the deputy mode has been activated and when said processing unit receives, via said communication interface, a designator-to-designee message which is transmitted by the designator-side device and which is directed to the designee-side device, transmit, based on the designee setting information, the designator-to-designee message to the designee-side device instantly via said communication interface.

18. The instant messaging server of claim 15, wherein said processing unit is configured to, when the deputy mode has been activated and when said processing unit receives, via said communication interface, a designee-to-designator message which is transmitted by the designee-side device and which is directed to the designator-side device, transmit, based on the designee setting information, the designee-to-designator message to the designator-side device instantly via said communication interface.

19. The instant messaging server of claim 15, wherein said processing unit is configured to, when the deputy mode has been activated and when said processing unit receives, via said communication interface, an object-to-designator message which is transmitted by the object-side device and which is directed to the designator-side device, transmit, based on the designee setting information, the object-to-designator message to both of the designator-side device and the designee-side device instantly via said communication interface.
